(19) United States
(12) Patent Application Publication
(10) Pub. No.: US 2003/0143062 A1
(43) Pub. Date: Jul. 31, 2003

(54) Vaccum lifting apparatus etc.

(76) Inventor: Stewart Bennison, Chesterfield (GB)

Correspondence Address: KING & SCHICKLI, PLLC, 247 NORTH BROADWAY, LEXINGTON, KY, 40507, US

(21) Appl. No.: 10/351,123

(22) Filed: Jan. 24, 2003

(30) Foreign Application Priority Data
Jan. 26, 2002 (GB) 0201837.2

(51) Int. Cl. B25J 15/06

(52) U.S. Cl. 414/627; 294/64.1

(57) ABSTRACT

A vacuum lifting and handling apparatus (1) for product containers, comprises a lift tube (2) adapted to be suspended at its upper end (3) from an elevated location, and provided with a suction foot (14), the tube (2) being extendible and retractable under the influence of an internal vacuum, with a control unit (13) carried by a lower end (16) of the vacuum tube (2) to vary the internal vacuum as required during a container lifting and handling sequence by introduction of ambient air into the lift tube, and a replaceable air filter (17) is housed within the lower end (16) of the lift tube (2).

### FIELD OF THE INVENTION

This invention relates to vacuum lifting apparatus and a valve unit for the handling of product containers such as sacks, kegs, boxes etc, particularly for the discharging of a product, such as a dusty, powdery or granular material, from a container.

### BACKGROUND OF THE INVENTION

Known vacuum lifting apparatus comprises a variable length lift tube suspended at its upper end from an overhead location, and carrying at its lower end both a manually operable control unit, and at least one suction foot adapted to engage a container to be handled. The interior of the tube is connected via a vacuum line to a remote vacuum pump and a filter, and the control unit is able to maintain, partially destroy, or fully destroy the vacuum within the tube depending on the handling sequence required.

Such apparatus is used for the handling of a variety of products, and some industries, particularly the pharmaceutical industry, must avoid the contamination of a second product, with residue, such as dust particles, of a previous product adhering to the apparatus from a previous handling operation.

Avoidance of contamination is sought to be achieved by wash or wipe down operations and/or immersion of components in a washing fluid before a container of a second product can be handled, but previous designs of vacuum lifting apparatus, being intended for industrial applications where any contamination was generally of no consequence, do not readily lend themselves to on-site cleaning operations, in addition to the suction foot and control unit as product contamination can occur within the lift tube, and the vacuum line back to the remote filter—all of which require disassembly, cleaning and reassembly.

In addition, valve arrangements for adjusting the vacuum level and for setting the apparatus in an unloaded state etc can be improved.

### OBJECT OF THE INVENTION

Basic objects of the invention are the provision of an improved vacuum lifting and handling apparatus for a container, and to a valve unit for such apparatus.

### SUMMARY OF THE INVENTION

According to a first aspect of the invention, there is provided a vacuum lifting and handling apparatus for product containers, the apparatus comprising a lift tube adapted to be suspended at its upper end from an elevated location, and provided with a suction foot, the tube being extendible and retractable under the influence of an internal vacuum, with a control unit carried by a lower end of the vacuum tube to vary the internal vacuum as required during a container lifting and handling sequence by introduction of ambient air into the lift tube, wherein a replaceable air filter is housed within the lower end of the lift tube.

### ADVANTAGES OF THE INVENTION

By housing the air filter within the lower end of the lift tube, no product contamination can occur beyond the filter. Consequently, no cleaning downstream of the filter to the vacuum pump, is required, so that only changing of the filter, and firstly the number of components requiring cleaning is reduced, and secondly it is a relatively straightforward operation to clean the remaining components viz the control unit, vacuum lifting head and exterior of the tube, by dismantling eg for cleaning in a remote area.

### PREFERRED OR OPTIONAL FEATURES

The lower end of the lift tube is provided with a differential pressure gauge (eg a magnahelix gauge).

The gauge is carried by a rigid collar defining the lower end of the lift tube.

A housing for the air filter, co-axial with the lift tube passes, through the rigid collar.

The filter housing is provided at an upper end with a threaded boss, whereby an air filter may be manually screwed into, or from, the boss.

The lower end of the filter housing is provided with a manually releasable split collar (eg a TRICLOVER collar) by which the control unit is releasably attachable to the lower end of the lift tube.

A manually operable valve unit is attached to the control unit by means of a releasable split collar (eg a TRICLOVER collar).

Consequently, the valve unit is readily releasable from the control unit for washing and then refitting to the control unit, and the control unit is readily releasable from the lift tube for washing and then refitting.

The suction foot is permanently attached to the control unit.

The suction foot is releasably attached to the control unit by a manually operable split collar (eg a TRICLOVER collar).

The lift tube is provided with an outer cover of flexible material, the cover being readily attachable and removable for the fitting of a replacement cover, and/or of a material that may be readily washed down and that discourages the adherence of particles of products.

The filter is removed by locating a work table beneath the lift tube that carries an open refuse bag supplied from the work table, with a tie or other closable and/or sealable upper end, then the control unit is removed, then the split collar attached to the filter housing is opened and the operator inverts the refuse bag, grips and unscrews the filter so that the latter falls into the then deployed refuse bag, and the top tie is closed.

A rod passes co-axially through the air filter, and is provided at an upper end with a valve plate and an adjusting screw, the valve plate lowering to a bleed position whereby the lift tube finds a balanced, hover position. This avoids the operator having to bear the weight during filter changing, or when changing from one control head to another.

The valved control unit comprises a manually and/or automatically adjustable, multi-position valve plate, communicating with a support tube for a suction foot, which tube extends from the lift tube, and is subjectable to the positive or negative air pressure within the lift tube

The valve plate provides for vacuum settings within the support tube, and hence within the lift tube during different phases of a container handling sequence, or an idle mode between handling operations.

The valve plate has three positions for three different vacuum modes eg for an idle/balance mode, a container lifting mode, and a container release mode.

The valve plate is carried at one end of an arm which projects from the support tube into the valve unit and is attached to a pivot pin supported by the valve unit, from which pin also projects a handle for manual positional adjustment of the valve plate.

The support tube is linear.

The support tube is an elbow.

The elbow version is for engagement of a suction foot with the side of a container eg the side of a de-lidded fibre bin for handling operations which involve inverting the container to tip or pour the contents from the container.

To achieve inversion of a container, the suction foot is rotatable on a pin joint.

The pin joint has a release catch if conditions are such that the container can be pulled by hand from an initial, upright position, to an inverted position.

Where hand pulling is not possible, the pin joint has a square socket for engagement by a drive dog of a worm and wheel device with a handwheel for the operator, or connected to a pneumatic or electric motor drive.

The worm and wheel device is mountable on the support tube by a split collar (eg a TRICLOVER collar).

The elbow support tube is provided at its end remote from the suction foot with a balance weight.

Although suction foot has been referred to in the singular, certain containers may require multiple suction feet located along a suction beam.

One example of vacuum lifting apparatus and valve arrangement in accordance with the first and second aspects are shown in the accompanying drawings, in which:

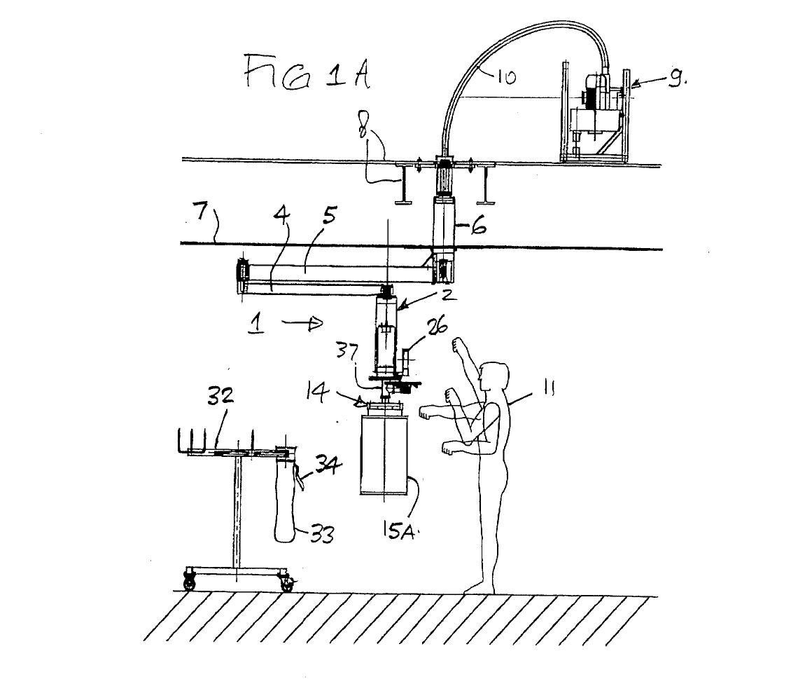

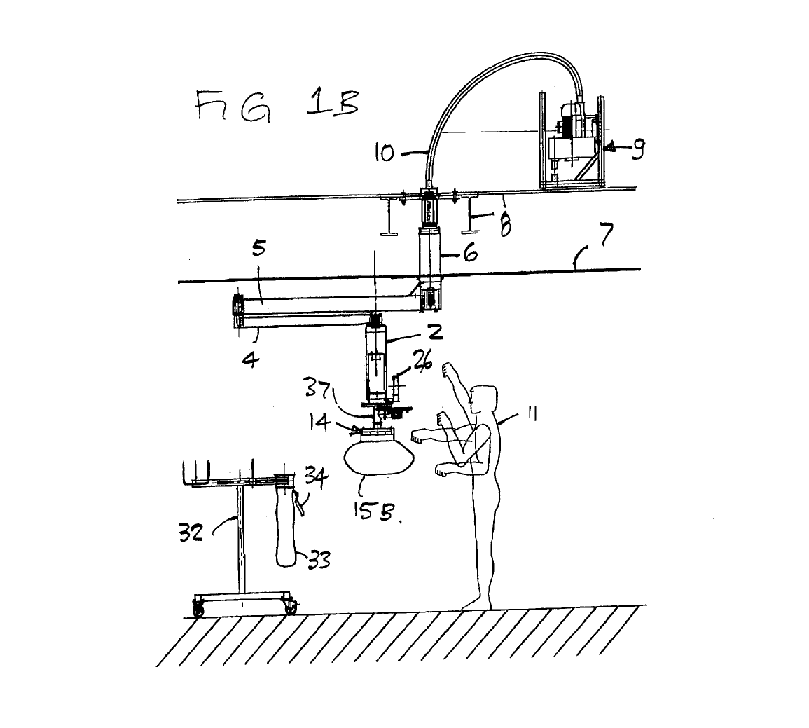

FIGS. 1A, 2A and 3A are diagrammatic, side elevations of apparatus in accordance with the invention handling different product containers;

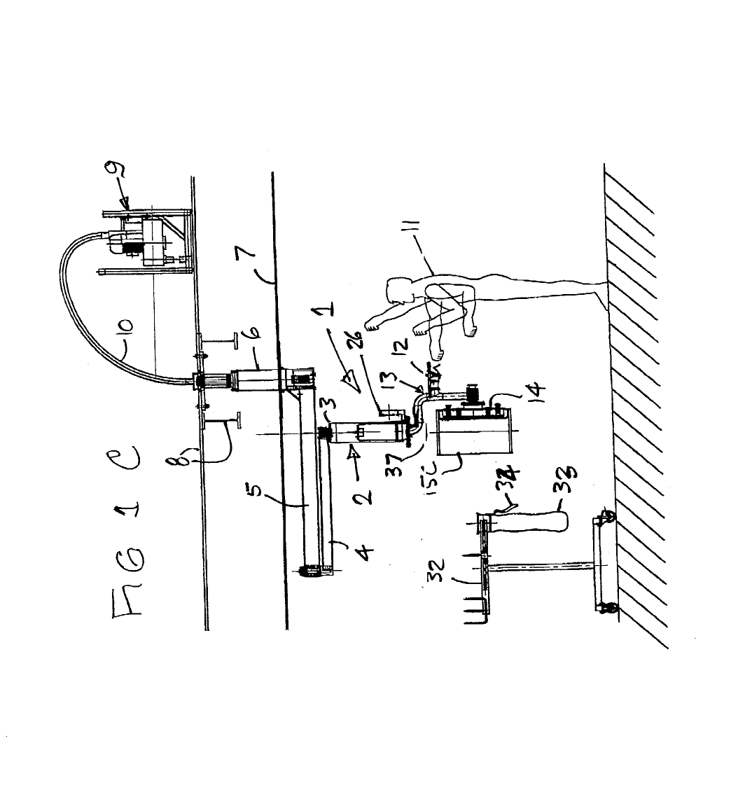

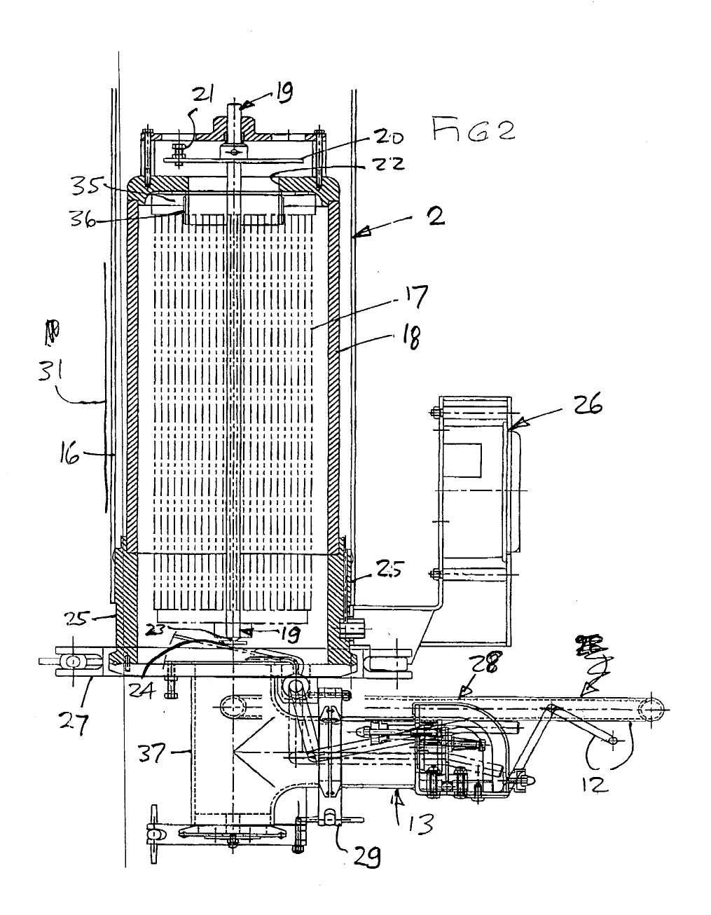

FIG. 2 is a detailed enlargement of the lower end of the lift tube of FIGS. 1A, 2A and 3A; and

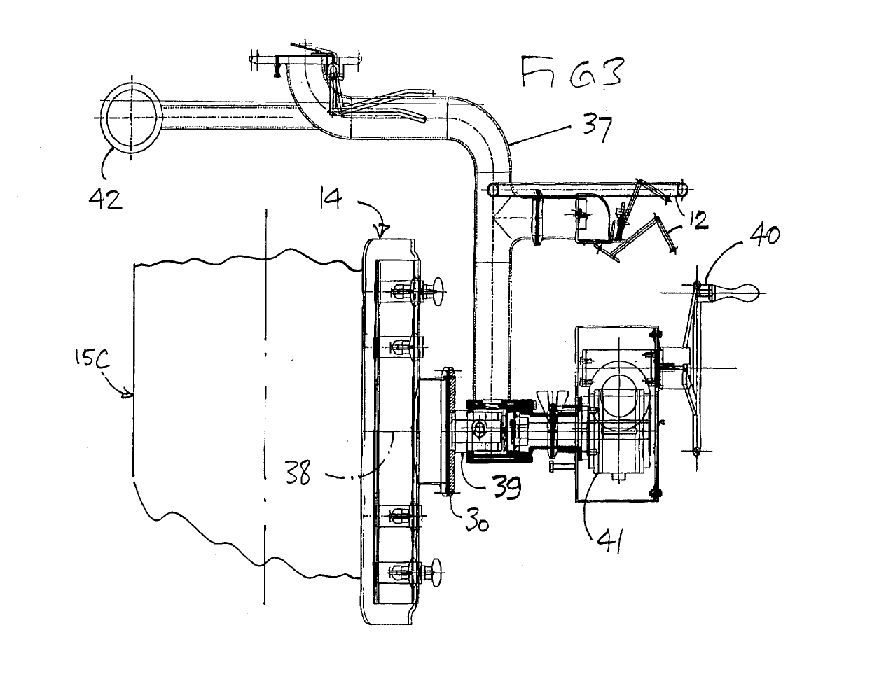

FIG. 3 is also a detailed enlargement of a portion of the apparatus in an embodiment requiring inversion of the container

In all figures, like components are accorded like reference numerals.

A vacuum lifting and handling apparatus 1 comprises a lift tube 2 suspended from its upper end 3 by being attached to swing arms 4, 5. Arm 5 is also pivotally attached to a support 6 passing through a false ceiling 7 to steelwork supporting structure 8, which also carries a vacuum pump 9 and connected tubing 10. The pump 9 serves to create a vacuum in the lift tube 2 which vacuum can be partially destroyed under manual control of an operator 11 by operation of levers/hand grips 12 of valved control unit 13. Below the lift tube is an exchangeable suction foot 14 (also known as a vacuum lifting head). The type of suction foot is chosen to suit the product container to be handled. In FIG. 1A the container is a keg 15A, while in FIG. 1B, the container is a sack 15B, and in FIG. 3 the container is a keg 15A requiring inversion to discharge its contents.

All the above is known.

In accordance with the invention, and as best seen in FIG. 2, lower end 16 of the lift tube 2 is provided with a replaceable air filter 17 located within a housing 18 open at its lower end. It will be appreciated that the presence of the air filter 17 prevents powdery, air bourne particles produced eg during discharge of containers 15A etc from being drawn into the apparatus 1 and specifically the lift tube 2, by action of the vacuum pump 9. The housing 18 is provided at an upper end with a threaded boss 35, and the air filter 17 with a threaded collar 36, whereby the filter 17 may be manually screwed into and from the boss 35.

A rod 19 passes co-axially through the air filter 17 and has at its upper end a valve plate 20 with an adjusting screw 21, the valve plate 20, in a lower position (not shown) partially closing off aperture 22 in the housing 18 during air filter changing operations (to be explained later), when lower end 23 of the rod 19 which is engageable with a cross-bar 24.

This is designed to enable the lift tube 2 to find a balanced, hover position, so that the operator 11 need take no weight.

The lower end 16 of the left tube 2 is also provided with a rigid collar 25 which carries a differential pressure gauge 26, preferably a magnalix gauge, visible to the operator 11, the housing 18 passing through the rigid collar 25.

The lower end of the housing 18 is provided with a split collar 27 by which the valved control unit 13 is releasably attached to the lower end 16 of the lift tube 2, whilst a manually operable valve unit 28 is releasably attached to the control unit 13 by means of a split collar 29. The valved control unit 13 communicates with a support tube 37 for the suction foot 14 which extends from the lift tube 2.

As best seen in FIG. 3, the suction foot 14 is releasably attached to the valved control unit 13 by another manually operable split collar 30.

The lift tube 2 is provided with an outer covering 31 of flexible material which is readily attachable and removable for replacement or cleaning.

To remove the filter 17 for cleaning and/or replacement, a work table 32 is located beneath the lift tube 2, and carries an open refuse bag 33 closable by a tie 34.

The control unit 13 is then removed, then the split collar 27 is opened. The operator 11 then grips the bottom of refuse bag 32 and with a portion of the refuse bag 32 interposed, grips and unscrews the air filter 17 so that the filter 17 falls into the bag 32, and the tie 34 is closed by the operator 11. A replacement filter 17 eg for a different pharmaceutical product to be handled, is then screwed into place by the operator 11 and the collar 27 closed and the control unit 13 replaced.

The embodiment shown in FIG. 1C and FIG. 3 is suitable for use where inversion of the container 15C is required, the suction foot 14 being rotatable about axis 38 on a pin joint 39 by a handwheel 40 operable via gearing 41, the foot 14 etc being carried by a cranked or elbowed support tube 37, provided at an end remote from the suction foot 14 with a balance weight 42.

1. A vacuum lifting and handling apparatus for product containers, said apparatus comprising a lift tube adapted to be suspended at its upper end from an elevated location, and provided at its lower end with a suction foot, said lift tube being extendible and retractable under the influence of an internal vacuum, with a control unit carried by a lower end of said lift tube to vary the internal vacuum as required during a container lifting and handling sequence by introduction of ambient air into said lift tube, wherein a replaceable air filter is housed within said lower end of said lift tube.

2. Apparatus as claimed in claim 1, wherein said lower end of said lift tube is provided with a differential pressure gauge.

3. Apparatus as claimed in claim 2, wherein said differential pressure gauge is carried by a rigid collar at said lower end of said lift tube.

4. Apparatus as claimed in claim 3, wherein a housing for said air filter, which is co-axial with said lift tube, passes through said rigid collar.

5. Apparatus as claimed in claim 1, wherein a rod passes co-axially through said air filter, and is provided at an upper end with a valve plate and an adjusting screw, said valve plate being lowerable to a bleed position whereby said lift tube finds a balanced, hover position.

6. Apparatus as claimed in claim 1, wherein said control unit comprises a manually and/or automatically adjustable, multi-position valve plate, communicating with a support tube for said suction foot, which said support tube extends from said lift tube, and is subjectable to positive or negative air pressure within said lift tube.

7. Apparatus as claimed in claim 6, wherein said support tube is linear.

8. Apparatus as claimed in claim 6, wherein said support tube is an elbow.

9. Apparatus as claimed in claim 8, wherein said suction foot is rotatable on a pin joint.
